(19) United States
(12) Patent Application Publication
(10) Pub. No.: US 2025/0342701 A1
(43) Pub. Date: Nov. 6, 2025

(54) MONITORING SUPPORT APPARATUS, MONITORING SUPPORT SYSTEM, AND PROGRAM

(71) Applicant: KYOCERA Corporation, Kyoto-shi, Kyoto (JP)

(72) Inventor: Ryosuke WATANABE, Yokohama-shi, Kanagawa (JP)

(73) Assignee: KYOCERA Corporation, Kyoto-shi, Kyoto (JP)

(21) Appl. No.: 18/870,771

(22) PCT Filed: Jun. 2, 2023
(86) PCT No.: PCT/JP2023/020664

§ 371 Date: Dec. 2, 2024

(30) Foreign Application Priority Data
Jun. 30, 2022 (JP) 2022-106700

(51) Int. Cl. G06V 20/54; G06V 20/58; H04N 7/18

(52) U.S. Cl. CPC G06V 20/54; G06V 20/58; H04N 7/183

(57) ABSTRACT

A monitoring support apparatus includes an image acquirer, an identifier, and an image generator. The image acquirer is configured to acquire an image observed from a mobile unit and captured. The identifier is configured to obtain information regarding a target that has brought the mobile unit to a halt. The image generator is configured to generate a superposed image by displaying in the image acquired by the image acquirer a picture indicating a position of the target during a predetermined period.

### CROSS-REFERENCE TO RELATED APPLICATIONS

This application claims priority from Japanese Patent Application No. 2022-106700 (filed Jun. 30, 2022), the content of which is all incorporated herein by reference.

### TECHNICAL FIELD

The present disclosure relates to a monitoring support apparatus, a monitoring support system, and a program.

### BACKGROUND OF INVENTION

Technologies have been developed in recent years to achieve practical use of autonomous driving that enables an automobile to run autonomously (without driving operation by a human) at least partially. Autonomous driving may be graded, for example, based on the levels set by a public service corporation in Japan, JSAE (the Society of Automotive Engineers of Japan, Inc.), or a nonprofit organization in the U.S., SAE (the Society of Automotive Engineers). While autonomous driving may be developed or put to practical use to a certain degree, a human watcher may need to perform, for example, remote monitoring to handle, for example, an unforeseen event. To meet such a requirement, Patent Literature 1 proposes, for example, a remote vehicle-monitoring support system configured to enable a vehicle to continue running with remote operation support from an operator working for a control center when the vehicle is difficult to run.

### CITATION LIST

### Patent Literature

Patent Literature 1: Japanese Unexamined Patent Application Publication No. 2020-42764

### SUMMARY

### Solution to Problem

In an embodiment, a monitoring support apparatus includes an image acquirer, an identifier, and an image generator.

The image acquirer is configured to acquire an image observed from a mobile unit and captured.

The identifier is configured to obtain information regarding a target that has brought the mobile unit to a halt.

The image generator is configured to generate a superposed image by displaying in the image acquired by the image acquirer a picture indicating a position of the target during a predetermined period.

In an embodiment, a monitoring support system includes a communicator, an image acquirer, an identifier, an image generator, and a display.

The communicator is configured to receive an image observed from a mobile unit and captured.

The image acquirer is configured to acquire the image received by the communicator.

The identifier is configured to obtain information regarding a target that has brought the mobile unit to a halt.

The image generator is configured to generate a superposed image by displaying in the image acquired by the image acquirer a picture indicating a position of the target during a predetermined period.

The display is configured to present the image generated by the image generator.

In an embodiment, a program includes instructions causing a computer to execute
acquiring an image observed from a mobile unit and captured;
obtaining information regarding a target that has brought the mobile unit to a halt; and
generating a superposed image by displaying, in the image acquired by the acquiring, a picture indicating a position of the target during a predetermined period.

### BRIEF DESCRIPTION OF THE DRAWINGS

FIG. 1 is a block diagram schematically illustrating a configuration of a monitoring support system according to an embodiment.

FIG. 2 is a block diagram illustrating a functional configuration of a monitoring support apparatus according to an embodiment.

FIG. 3 illustrates how the monitoring support system is used according to an embodiment.

FIG. 4 illustrates how the monitoring support system is used according to an embodiment.

FIG. 5 is a flowchart illustrating an operation of the monitoring support apparatus according to an embodiment.

FIG. 6A illustrates an example of the operation of the monitoring support apparatus according to an embodiment.

FIG. 6B illustrates an example of the operation of the monitoring support apparatus according to an embodiment.

FIG. 6C illustrates an example of the operation of the monitoring support apparatus according to an embodiment.

FIG. 6D illustrates an example of the operation of the monitoring support apparatus according to an embodiment.

FIG. 6E illustrates an example of the operation of the monitoring support apparatus according to an embodiment.

FIG. 6F illustrates an example of the operation of the monitoring support apparatus according to an embodiment.

FIG. 7 illustrates an example of the operation of the monitoring support apparatus according to an embodiment.

FIG. 8 illustrates an example of the operation of the monitoring support apparatus according to an embodiment.

### DESCRIPTION OF EMBODIMENTS

Reducing a load on a person (watcher) who monitors a traffic condition for a mobile unit is desired in a monitoring system for mobile units such as automobiles. The present disclosure provides a monitoring support apparatus, a monitoring support system, and a program that enable a reduction in a load on a person (watcher) who monitors a traffic condition for a mobile unit. An embodiment is able to provide a monitoring support apparatus, a monitoring support system, and a program that enable a reduction in a load on a person (watcher) who monitors a traffic condition for a mobile unit.

In the present disclosure, a “monitoring support apparatus” may be an electronic apparatus powered by electric power. A “monitoring support system” may include an apparatus powered by electric power (for example, a monitoring support apparatus). A “user” may be a person who uses the monitoring support apparatus or the monitoring support system according to an embodiment. A user may be a person who is able to benefit by using the monitoring support apparatus or the monitoring support system according to an embodiment.

In an embodiment, the monitoring support apparatus or the monitoring support system may be used, for example, at a facility, such as a traffic monitoring center, where traffic conditions for mobile units such as automobiles running on a road are remotely monitored. Such a facility is simply referred to as a “monitoring facility” hereinafter. A “watcher” refers to a person who uses the monitoring support apparatus or the monitoring support system to monitor a traffic condition for a mobile unit or the like in the monitoring facility. In short, the watcher is able to monitor a traffic condition for a mobile unit such as an automobile by using the monitoring support apparatus or the monitoring support system in the monitoring facility.

In an embodiment described below, a mobile unit such as an automobile to be monitored by the watcher is assumed to be transmitting to the monitoring support system an image observed from the mobile unit and captured with an image capture device in the mobile unit. Such image transmission may be performed, for example, at all times. The monitoring support system is configured to receive an image transmitted from the mobile unit, and a display such as a display screen is configured to present the image in the monitoring support system. The watcher watches the image presented by the monitoring support system and is able to monitor a traffic condition for the mobile unit.

For example, when an automobile becomes unable to continue autonomous driving for some reason and is brought to a halt during autonomous driving, the watcher is expected to use the monitoring support system to check the reason for the halt. Thereafter, the watcher is also expected to remotely operate the automobile if necessary or if possible after confirming that there is no problem around the automobile. Alternatively, if the driver is able to drive the automobile, the watcher may remotely support the driver in driving. For example, the driver who drives the automobile or the automobile during autonomous driving is also expected to send to the watcher a request for an action, such as a request for remote operation. In such a situation, the watcher is also expected to remotely operate the automobile or remotely support the driver in driving if necessary or if possible after confirming that there is no problem around the automobile. Such remote operation or remote support may be performed by the watcher or delegated to another person (for example, an operator who specializes in operation), for example, based on instructions from the watcher.

In a situation such as described above, the watcher may simultaneously monitor multiple automobiles alone because of operation efficiency. In such a case, the monitoring support system may cause a display such as a display screen visible to a single watcher to arrange and present images observed from multiple automobiles and captured. Using such a monitoring support system, the watcher is able to successively respond to various requests or the like received from automobiles or drivers while simultaneously monitoring traffic conditions for multiple automobiles. In an embodiment, description will be given with regard to the monitoring support system and the monitoring support apparatus being used in the mode described above.

A mobile unit such as an automobile monitored by the watcher may be autonomously driven (for example, in level 3 to level 5), driven partially autonomously (for example, in level 2), or driven by a driver (for example, in level 0 or level 1). A mobile unit such as an automobile monitored by the watcher is not limited to an ordinary passenger car and may be any automobile such as a bus, a truck, an ambulance car, a fire engine, or a patrol car. A mobile unit monitored by the watcher is not necessarily limited to an automobile and may be another mobile unit able to participate in a road traffic.

Referring to the drawings, description will be given hereinafter with regard to a monitoring support apparatus and a monitoring support system according to an embodiment.

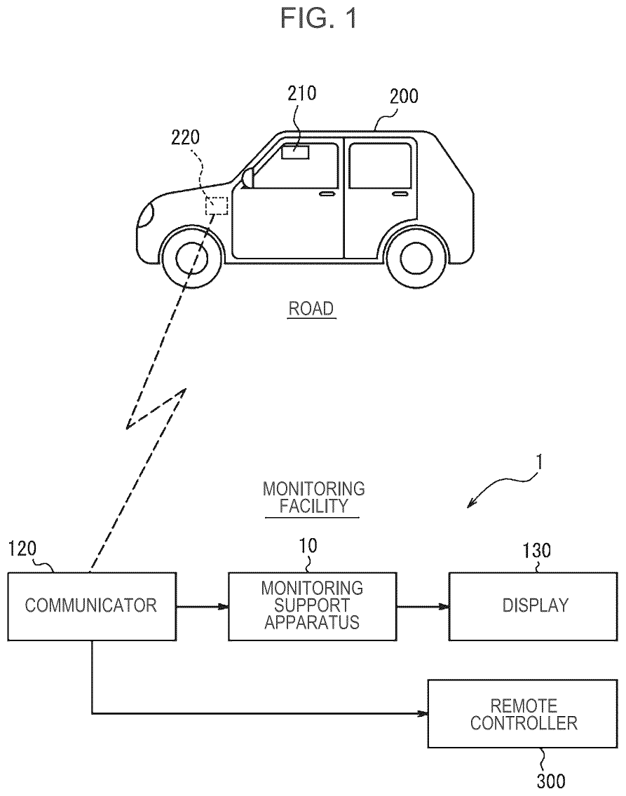

FIG. 1 illustrates a monitoring support system including a monitoring support apparatus according to an embodiment together with a mobile unit such as an automobile.

As illustrated in FIG. 1, a monitoring support system 1 may include a monitoring support apparatus 10, a communicator 120, and a display 130. The monitoring support system 1 may support monitoring of a mobile unit 200 such as an automobile. The monitoring support system 1 may be installed, for example, in a monitoring facility. The mobile unit 200 may be driven by a driver, driven at least partially autonomously, or remotely operated, for example, by a remote controller 300. The mobile unit 200 may be, for example, on a road.

The mobile unit 200 may be, for example, an automobile. The mobile unit 200 may be, for example, an ordinary passenger car. The mobile unit 200 is not limited to an ordinary passenger car and may be any automobile such as a bus, a truck, an ambulance car, a fire engine, or a patrol car. The mobile unit 200 is not necessarily limited to an automobile and may be another mobile unit able to participate in a road traffic.

Description will be given hereinafter on the assumption that the mobile unit 200 is a passenger car. The mobile unit 200 may be powered by various kinds of driving power, and examples of the mobile unit 200 include an engine-driven vehicle, an electric vehicle, and a fuel-cell vehicle.

The mobile unit 200 may be capable of being autonomously driven (for example, in level 3 to level 5), driven partially autonomously (for example, in level 2), or driven by a driver (for example, in level 0 or level 1). As illustrated in FIG. 1, the mobile unit 200 may include, for example, an imager 210 and a communicator 220. A subset of functional units illustrated in FIG. 1 may be omitted from the mobile unit 200, and a functional unit other than the functional units illustrated in FIG. 1 may be added to the mobile unit 200.

The imager 210 is able to capture an image. The imager 210 may include an image sensor configured to electronically capture a picture, such as a digital camera. The imager 210 may include an imaging device configured to perform photoelectric conversion, such as a CCD (charge coupled device image sensor) or CMOS (complementary metal oxide semiconductor) sensor. The imager 210 is not limited to an imaging device such as a digital camera and may be any device. An image captured by the imager 210 may be a still image, consecutive still images, or a moving image. An “image” collectively refers to what is captured by the imager 210 hereinafter, and examples of an image include a still image, consecutive still images, and a moving image.

The imager 210 may be disposed at any position in or on the mobile unit 200. The imager 210 may be fixed to the mobile unit 200. The imager 210 may be disposed in a movable way in or on the mobile unit 200 so that an image capture range may be changed.

In an embodiment, the imager 210 may usually capture a view ahead of the mobile unit 200. In particular, the imager 210 may capture an image that centers around the view ahead of the mobile unit 200 and that allows a traffic condition (environment) for the mobile unit 200 to be grasped. Image data captured by the imager 210 may be transmitted to the communicator 220. The imager 210 may be connected to the communicator 220 using at least one of wireline or wireless communication.

The communicator 220 in the mobile unit 200 may be a functional unit able to connect to and communicate with the communicator 120 in the monitoring support system 1 using at least one of wireline or wireless communication (usually wireless communication). The communicator 220 may be a dedicated hardware component installed at the mobile unit 200, or a general-purpose product such as a smartphone or a tablet terminal may be used as the communicator 220.

The communicator 220 has an interface function to perform wireline or wireless communication. In an embodiment, communication performed by the communicator 220 may be based on a wireless communication standard. Examples of the wireless communication standard may include the cellular phone standards such as 2G, 3G, 4G, and 5G. Examples of the cellular phone standard include LTE (long term evolution), W-CDMA (wideband code division multiple access), CDMA 2000, PDC (personal digital cellular), GSM (registered trademark) (global system for mobile communications), and PHS (personal handy-phone system). Examples of the wireless communication standard includes WiMAX (worldwide interoperability for microwave access), IEEE 802.11, WiFi, Bluetooth (registered trademark), IrDA (infrared data association), and NFC (near field communication). The communicator 220 is able to support one or more communication standards mentioned above. The communicator 220 may include, for example, an antenna configured to transmit and receive an electromagnetic wave and an appropriate RF unit. The communicator 220 may include an interface such as a connector for wireline connection to an external apparatus. Since the communicator 220 may be implemented with a known technology for performing wireless communication, more detailed description will be omitted with regard to the hardware or the like.

The mobile unit 200 may include various kinds of sensors or the like to detect various kinds of status at various places in the mobile unit 200. Such various kinds of sensors may be connected to the communicator 220 using at least one of wireline or wireless communication. The mobile unit 200 may include a component such as an ECU (engine control unit) configured to detect various kinds of status at various places in the mobile unit 200. In this case, the ECU may be connected to the communicator 220 using at least one of wireline or wireless communication.

The mobile unit 200 may have various functions required to perform autonomous driving at least partially. Various types of technologies may be adopted with regard to autonomous driving, whether it is available now and/or will be available in future. The mobile unit 200 may have various functions that enable a person other than a driver or a passenger in the mobile unit 200 to remotely operate (remotely control) the mobile unit 200. Various types of technologies may be adopted with regard to such remote operation (remote control), whether it is available now and/or will be available in future.

The remote controller 300 may be a controller configured to remotely operate (remotely control) the mobile unit 200. The remote controller 300 may include, for example, at least any one of a joystick, a slider, a touch pad or touch panel, and/or various switches. For example, an operator (operating person) stationed at the monitoring facility is able to remotely operate the mobile unit 200 using the remote controller 300.

The remote controller 300 may be connected to the communicator 120 in the monitoring support system 1 using at least one of wireline or wireless communication. The remote controller 300 is connected to the communicator 120, thereby communicates with the communicator 220, and is able to remotely operate the mobile unit 200.

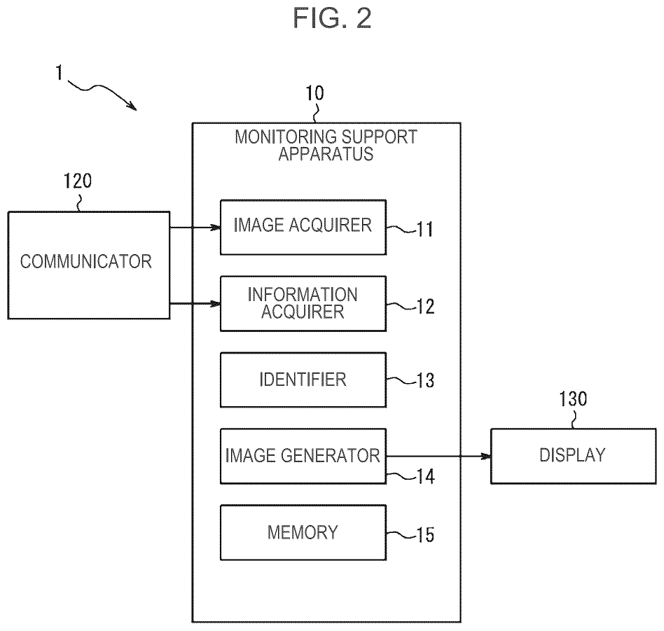

FIG. 2 is a block diagram illustrating a functional configuration of the monitoring support system 1 according to an embodiment. As illustrated in FIG. 2, the monitoring support system 1 may include the monitoring support apparatus 10, the communicator 120, and the display 130.

The communicator 120 has an interface function to perform wireline or wireless communication. The communicator 120 may have a function to perform wireline or wireless communication with the communicator 220 in the mobile unit 200. The communicator 120 may be a functional unit based on a design principle that is the same as and/or similar to a design principle of the communicator 220. As a functional unit configured to communicate with the communicator 220 using wireless communication, the communicator 120 may be a functional unit based on a design principle that is the same as and/or similar to a design principle of a known wireless communication device such as an RF unit. As a functional unit configured to communicate with the communicator 220 using wireline communication, the communicator 120 may be a functional unit based on a design principle that is the same as and/or similar to a design principle of a device such as a connector. Since the communicator 120 may be implemented with a known technology, more detailed description will be omitted.

The display 130 may be any display device, such as an LCD (liquid crystal display), an organic EL display (organic electro-luminescence panel), or an inorganic EL display (inorganic electro-luminescence panel). The display 130 may present various types of information including a character, a figure, and a symbol. For example, the display 130 may present objects used to form various GUIs, an icon image, and the like to prompt a user to operate the monitoring support apparatus 10 or the mobile unit 200. The display 130 may be a functional unit based on a design principle that is the same as and/or similar to a design principle of a known display device described above. Since the display 130 may be implemented with a known technology, more detailed description will be omitted.

As illustrated in FIG. 2, the monitoring support apparatus 10 may include an image acquirer 11, an information acquirer 12, an identifier 13, an image generator 14, and a memory 15. A subset of functional units illustrated in FIG. 2 may be omitted from the monitoring support apparatus 10, and a functional unit other than the functional units illustrated in FIG. 2 may be added to the monitoring support apparatus 10. For example, in an embodiment, the monitoring support apparatus 10 may include the image acquirer 11, the identifier 13, and the image generator 14.

In an embodiment, the monitoring support apparatus 10 may be implemented as various electronic devices. For example, the monitoring support apparatus 10 may be a terminal designed exclusively for this purpose, a general-purpose computer, a notebook computer, or a server. The monitoring support apparatus 10 may also be a tablet computer, a smartphone, or the like.

The monitoring support apparatus 10 may include at least one processor such as a CPU (central processing unit) or a DSP (digital signal processor) to provide capability of control and processing to perform various functions. The monitoring support apparatus 10 may be implemented collectively using a single processor, using several processors, or using individual processors. The at least one processor may be implemented as a single integrated circuit (IC). The at least one processor may be implemented as multiple integrated circuits and discrete circuits communicatively connected to each other. The at least one processor may be implemented based on various other known technologies.

In an embodiment, the monitoring support apparatus 10 may be implemented, for example, as a CPU and a program to be executed by the CPU. The program to be executed in the monitoring support apparatus 10 and data such as a result of a process performed in the monitoring support apparatus 10 may be stored, for example, in the memory 15. The monitoring support apparatus 10 may include an adequate memory required for operation. The monitoring support apparatus 10 may be implemented as dedicated hardware, may be implemented so as to include software at least partially, or may be entirely implemented as software.

The image acquirer 11 is configured to acquire an image captured by the imager 210 in the mobile unit 200. In other words, the image acquirer 11 is configured to acquire an image observed from the mobile unit 200 and captured. The image acquirer 11 may acquire an image captured by the imager 210, for example, via the communicator 220 in the mobile unit 200 and the communicator 120 in the monitoring support system 1. As described above, the imager 210 may capture an image that centers around the view ahead of the mobile unit 200 and that allows a traffic condition (environment) for the mobile unit 200 to be grasped. For example, the image acquirer 11 may capture an image observed from the mobile unit 200 and captured by the imager 210 while the mobile unit 200 is running or stopped. In such a case, the image acquirer 11 may capture an image of an automobile, a motorcycle, a bicycle, a pedestrian, a stroller, a road, a building, a scene, and/or the like located, for example, ahead of the mobile unit 200.

The information acquirer 12 may acquire various types of information from each unit in or on the mobile unit 200. The information acquirer 12 may acquire various types of information, for example, via the communicator 220 in the mobile unit 200 and the communicator 120 in the monitoring support system 1. For example, the information acquirer 12 may acquire various types of information regarding the mobile unit 200 from the ECU in the mobile unit 200. The information acquirer 12 may acquire various types of information regarding autonomous driving of the mobile unit 200 from an electronic device such as a computer configured to control autonomous driving of the mobile unit 200. The information acquirer 12 may acquire various types of information regarding remote control of the mobile unit 200 from an electronic device such as a computer configured to control remote control of the mobile unit 200.

The identifier 13 may obtain information regarding a target that has brought the mobile unit 200 to a halt. The identifier 13 is configured to, based on an image acquired by the image acquirer 11, identify a target included in the image. As described above, the image acquirer 11 may acquire an image captured by the imager 210 in the mobile unit 200. In an embodiment, the identifier 13 may identify a target that has brought the mobile unit 200 to a halt based on an image acquired by the image acquirer 11 when the mobile unit 200 being autonomously driven has been brought to a halt. The identifier 13 may identify the type of the target and/or the moving speed of the target. In such a case, based on information received from the mobile unit 200, the identifier 13 may identify the target that has brought the mobile unit 200 to a halt. Based on information that is received from the mobile unit 200 regarding a cause of the halt of the mobile unit 200, the identifier 13 may identify the target that has brought the mobile unit 200 to a halt. Based on information acquired by the information acquirer 12, the identifier 13 may identify the target that has brought the mobile unit 200 to a halt. The watcher may specify a target in an image presented by the display 130, and thereby the identifier may identify the target that has brought the mobile unit 200 being autonomously driven to a halt.

The identifier 13 may recognize an object, for example, using image recognition. The identifier 13 may recognize an object using various technologies such as pattern matching. A piece of information regarding an object is associated with a picture of the object, and the identifier 13 may recognize objects based on the pieces of information regarding various objects. The pieces of information regarding various objects, each piece of information being associated with a picture of an object, may be stored, for example, in the memory 15 or may be requested, for example, from an external server or the like via the communicator 120. The identifier 13 may recognize an object based on, for example, AI (artificial intelligence) technology. The identifier 13 may recognize an object based on, for example, machine learning (or further, deep learning) technology.

For example, a pedestrian is assumed to try to cross in front of the mobile unit 200 while the mobile unit 200 is being autonomously driven. In such a case, the mobile unit 200 is expected to be controlled by autonomous driving to brake to a halt in response to detecting the pedestrian within a predetermined distance. In this case, the identifier 13 may identify the pedestrian trying to cross in front of the mobile unit 200 as the target that has brought the mobile unit 200 to a halt. For example, a bicycle is assumed to try to cross in front of the mobile unit 200 while the mobile unit 200 is being autonomously driven. In such a case, the mobile unit 200 is expected to be controlled by autonomous driving to brake to a halt in response to detecting the bicycle within a predetermined distance. In this case, the identifier 13 may identify the bicycle trying to cross in front of the mobile unit 200 as the target that has brought the mobile unit 200 to a halt. When the identifier 13 is unable to determine a target that has caused the halt, the watcher may be provided with an image captured by the imager 210 in the mobile unit 200 to allow the watcher to determine the cause of the halt. The number of the causes of the halt may be more than one.

When the identifier 13 is to identify a target that has brought the mobile unit 200 to a halt, the information acquirer 12 may acquire information regarding a target identified by an electronic device in the mobile unit 200. When the identifier 13 is to identify a target that has brought the mobile unit 200 to a halt, the image acquirer 11 may acquire an image captured by the imager 210 in the mobile unit 200, and the identifier 13 may identify the target based on the image.

The image generator 14 is configured to generate a predetermined image based on an image acquired by the image acquirer 11 and output the predetermined image. In an embodiment, the image generator 14 may generate a superposed image. A superposed image is an image generated by superposing pictures of the target that has brought the mobile unit 200 to a halt onto an image acquired by the image acquirer 11, the pictures of the target depicting changes in the target at predetermined intervals as time passes. The superposed image generated by the image generator 14 will further be described below. The watcher in the monitoring facility is able to monitor the mobile unit 200 by watching the image acquired by the image acquirer 11 and/or the superposed image generated by the image generator 14.

The image generated by the image generator 14 may be output to the display 130. The display 130 is provided with the image by the image generator 14 and thus is able to present the image generated by the image generator 14. The watcher in the monitoring facility is able to monitor the mobile unit 200 and its surroundings by watching the image presented by the display 130.

The memory 15 may have a function as a memory configured to store various types of information. For example, the memory 15 may store a program to be executed in the monitoring support apparatus 10 and data such as a result of a process performed in at least a part of the monitoring support apparatus 10. The memory 15 may have a function as a database configured to store various types of information. The memory 15 may serve as a working memory for at least a part of the monitoring support apparatus 10. The memory 15 may be implemented using a device such as a semiconductor memory as a non-limiting example, or may be implemented using any storage device. For example, in an embodiment, the memory 15 may be a recording medium such as a memory card inserted into the monitoring support apparatus 10. The memory 15 may be an internal memory of a CPU used in at least a part of the monitoring support apparatus 10 or may be separated from and connected to at least a part of the monitoring support apparatus 10.

The communicator 120 and the display 130 are illustrated as functional units separate from the monitoring support apparatus 10 in the monitoring support system 1 illustrated in FIG. 2. In an embodiment, however, the monitoring support apparatus 10 may include at least one of the communicator 120 or the display 130.

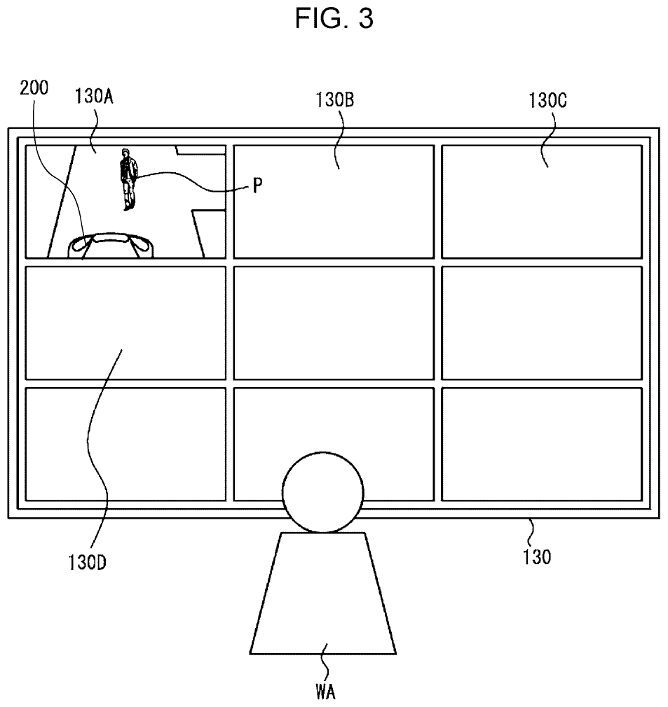

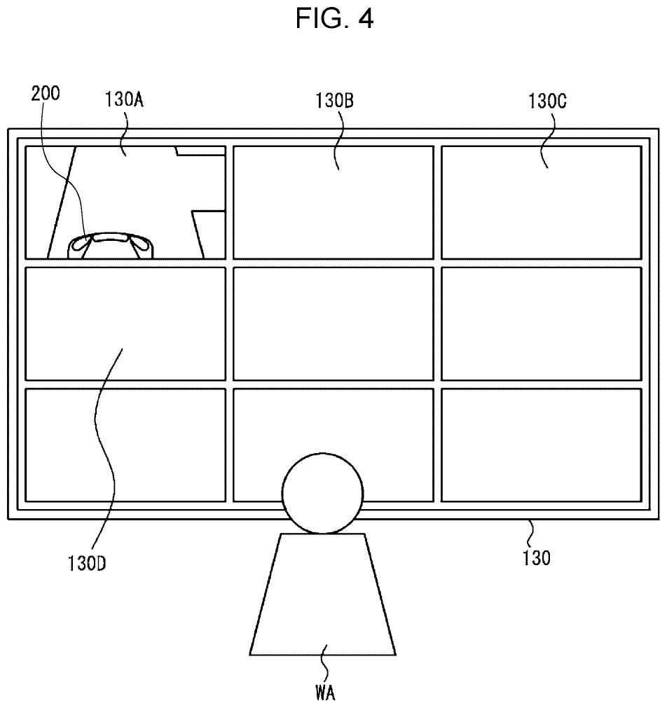

Description will be given with regard to how the monitoring support system 1 is used in an embodiment. FIG. 3 and FIG. 4 illustrate an example depicting how the monitoring support system 1 is used in an embodiment. FIG. 3 and FIG. 4 schematically illustrate how a watcher WA monitors the mobile unit 200 and the like using the monitoring support system 1 installed in a facility such as a monitoring facility.

As illustrated in FIG. 3 and FIG. 4, the watcher WA, who uses the monitoring support system 1, is able to monitor the mobile unit 200 and the like by watching the display 130. Monitoring the mobile unit 200 and the like may include not only monitoring the mobile unit but also monitoring its surroundings. FIG. 3 and FIG. 4 illustrate how the watcher WA watches the display 130. The display 130 is able to present an image that is output from the monitoring support apparatus 10 along with, for example, an image observed from a mobile unit and captured (an image transmitted from each mobile unit). The image that is output from the monitoring support apparatus 10 may include, for example, indications to provide various guides.

As illustrated in FIG. 3 and FIG. 4, the display 130 may include multiple display screens, such as a screen 130A, a screen 130B, a screen 130C, and a screen 130D. For example, the screen 130A, the screen 130B, the screen 130C, and the screen 130D may each present an image observed from a different mobile unit and captured. For example, the screen 130A, the screen 130B, the screen 130C, and the screen 130D may each present a different image observed from the same mobile unit and captured. For example, the screen 130A may be used to monitor the mobile unit 200. The screen 130B may be used to monitor a mobile unit other than the mobile unit 200. The screen 130C may be used to monitor a mobile unit other than the mobile units mentioned above. FIG. 3 and FIG. 4 each illustrate, for example, four screens, the screen 130A, the screen 130B, the screen 130C, and the screen 130D. The display 130 may present one or any number of screens. Using the display 130 of this type, the watcher WA is able to monitor multiple mobile units and the like.

For example, the screen 130A illustrated in FIG. 3 and FIG. 4 may be used to monitor the mobile unit 200. The screen 130A presents an image captured by the imager 210 disposed in or on the mobile unit 200. As illustrated in FIG. 3 and FIG. 4, the screen 130A presents a scene (view) ahead of the mobile unit 200 along with a part (front part) of the mobile unit 200 as an image of a view ahead of the mobile unit 200 captured by the imager 210. The screen 130A presents as a road ahead of the mobile unit 200 a junction (T-intersection) at which a road stretching straight ahead and a road stretching to the right intersect.

For example, the watcher WA, who is monitoring multiple mobile units in the monitoring support system 1, is assumed to be informed that the mobile unit 200 being autonomously driven has been brought to an emergency halt. The information indicating the emergency halt of the mobile unit 200 may be provided, for example, by the mobile unit 200 or by the autonomous driving system or the like of the mobile unit 200. The watcher WA may be alerted, for example, by some indication presented by the display 130 that the mobile unit 200 has been brought to an emergency halt. For example, in response to the mobile unit 200 being brought to an emergency halt, the screen 130A may be brightly flashed for an instant, the screen 130A may be enclosed by a red frame, or an object may be presented somewhere in the screen 130A to prompt attention.

Upon recognizing that the mobile unit 200 has been brought to an emergency halt, the watcher WA looks at the screen 130A and checks the surroundings of the mobile unit 200. The display 130 illustrated in FIG. 3 presents a pedestrian P in front of the mobile unit 200, which has been brought to an emergency halt. By checking such a situation, the watcher WA is able to grasp that the cause of the emergency halt of the mobile unit 200 is the pedestrian P. For example, the pedestrian P is assumed to be crossing the road on foot. In this situation, the watcher WA is able to instruct the mobile unit 200 not to move until the pedestrian P finishes crossing the road. For example, the watcher WA may instruct the autonomous driving controller of the mobile unit 200 or instruct the driver of the mobile unit 200. The watcher WA may remotely take over the control of the mobile unit 200 being autonomously driven and remotely drive the mobile unit 200 after the pedestrian P has finished crossing the road.

While waiting for the pedestrian P to cross the road, the watcher WA is able to monitor a mobile unit other than the mobile unit 200. For example, the watcher WA is able to check a condition of a mobile unit other than the mobile unit 200 by watching the screen 130B, the screen 130C, or the like. The watcher WA is assumed to resume checking the condition of the surroundings of the mobile unit 200 after time passes in this way. The pedestrian P is assumed to have finished crossing the road by this time. In this situation, as illustrated in FIG. 4, the watcher WA looks at the screen 130A and finds that the pedestrian P has already disappeared from the screen 130A.

Since the watcher WA has been paid attention to another situation for some time before looking again at the screen 130A illustrated in FIG. 4, the watcher WA may be unable to immediately recognize (recall) that the pedestrian P has brought the mobile unit 200 to an emergency halt. In other words, looking at the screen 130A illustrated in FIG. 4, the watcher WA is unable to grasp at a glance whether the situation allows the mobile unit 200 to safely resume moving.

Looking at the screen 130A illustrated in FIG. 4, the watcher WA may be unable to grasp whether the mobile unit 200 was going straight ahead or turning to the right before the emergency halt of the mobile unit 200. In short, looking at the screen 130A illustrated in FIG. 4, the watcher WA is unable to grasp the originally planned path at a glance, for example, when the watcher WA is to remotely take over the control of the mobile unit 200 being autonomously driven.

Thus, in view of the above issue, in an embodiment, the monitoring support apparatus 10 is configured to perform a supporting procedure to reduce a load on a person (watcher) who monitors a traffic condition for a mobile unit. In other words, in an embodiment, when a mobile unit is brought to a halt, the monitoring support apparatus 10 is able to allow the watcher to easily grasp the situation that has led to the halt. In an embodiment, when a mobile unit is brought to a halt, the monitoring support apparatus 10 is able to allow the watcher to easily grasp a path planned for the mobile unit before the halt.

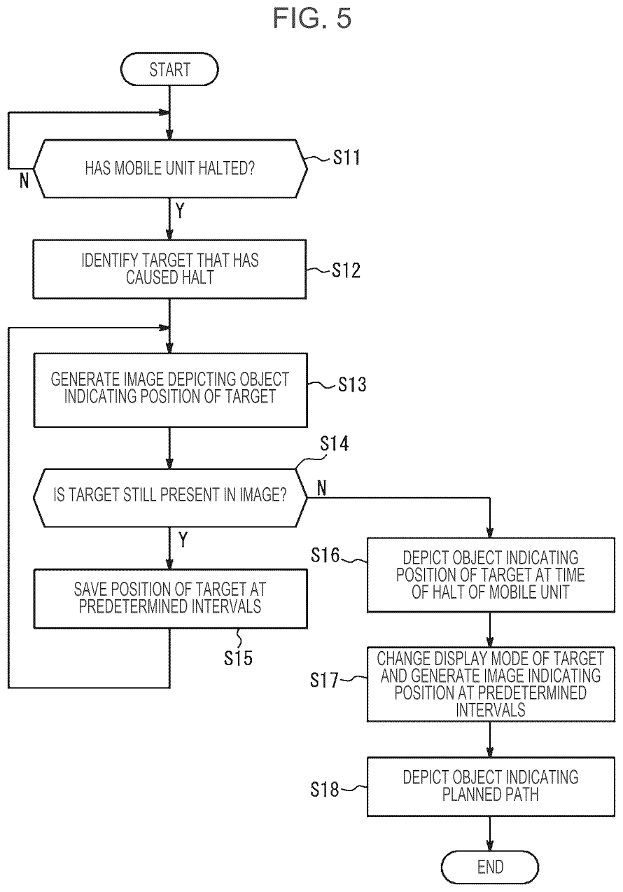

Description will be given hereinafter with regard to an operation of the monitoring support apparatus 10 according to an embodiment. FIG. 5 is a flowchart illustrating the operation of the monitoring support apparatus 10 according to an embodiment. FIG. 5 represents a normal operation to be performed by the monitoring support apparatus 10 while the mobile unit 200 is running on a road.

The operation illustrated in FIG. 5 may start while the mobile unit 200 as illustrated in FIG. 1 is being autonomously driven. The monitoring support apparatus 10 is assumed to be able to communicate with the mobile unit 200 (that is, the communicator 220 in the mobile unit 200) via the communicator 120 when the operation illustrated in FIG. 5 starts. The imager 210 in the mobile unit 200 is assumed to have captured an image of a view ahead of the mobile unit 200, and the image acquirer 11 is assumed to have acquired the image captured by the imager 210 when the operation illustrated in FIG. 5 starts. The information acquirer 12 may be assumed to have acquired various types of information regarding the mobile unit 200 when the operation illustrated in FIG. 5 starts.

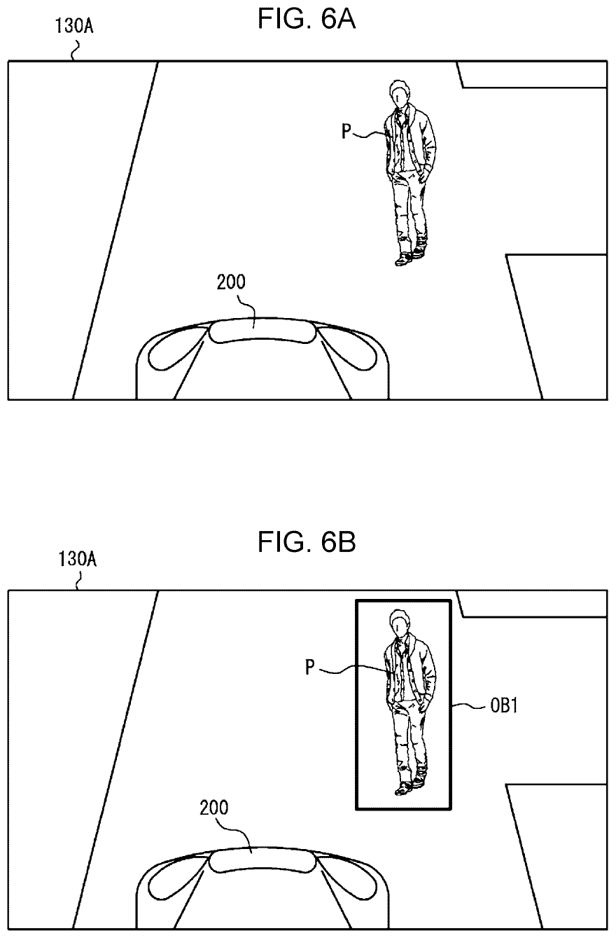

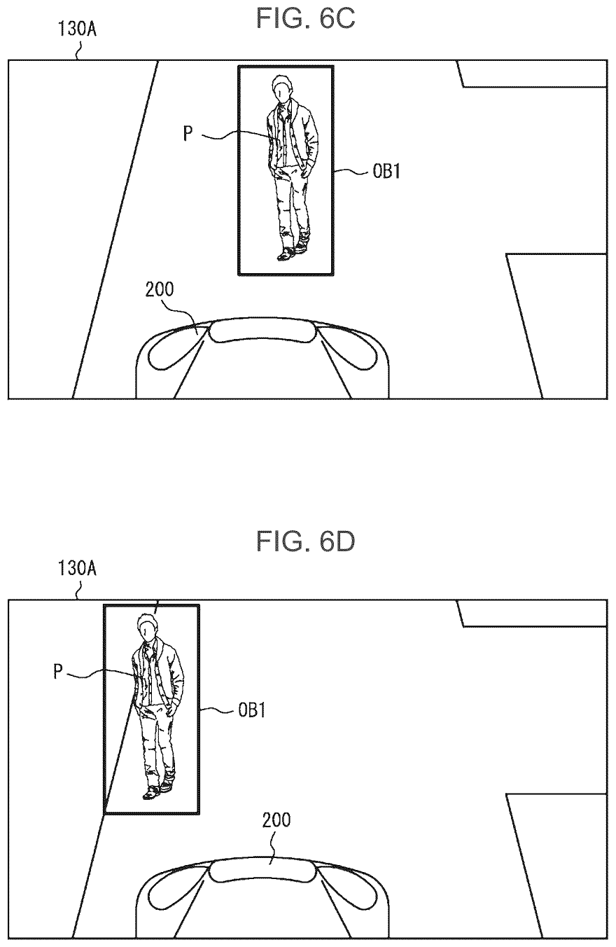

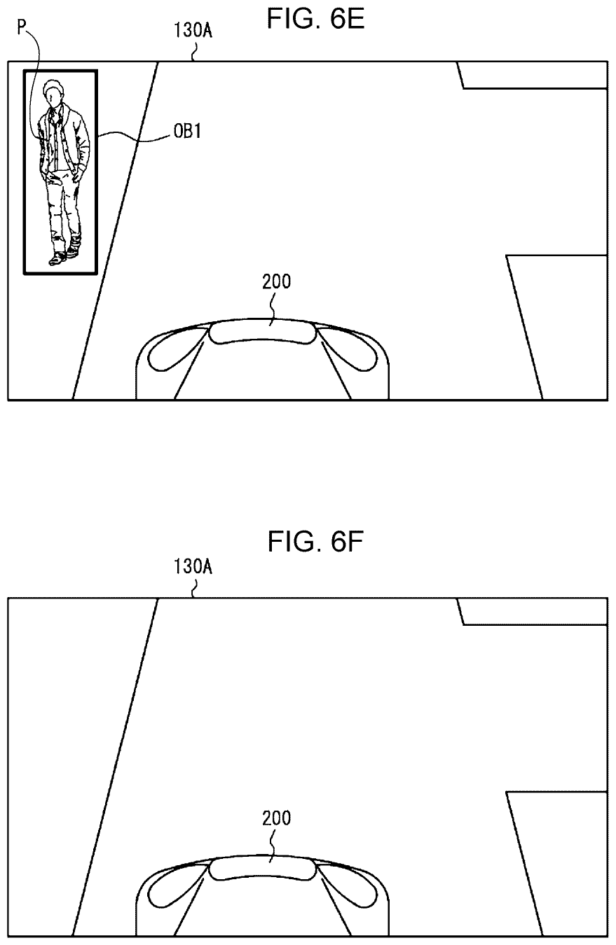

When the operation illustrated in FIG. 5 starts, the monitoring support apparatus 10 determines whether the mobile unit 200 has halted (step S11). In a typical example, as illustrated in FIG. 6A, the mobile unit 200 may halt when the mobile unit 200 detects an object such as a pedestrian P at a predetermined distance from the front of the mobile unit 200. The monitoring support apparatus 10 may determine whether the mobile unit 200 has halted based on information acquired by the information acquirer 12. For example, the monitoring support apparatus 10 may determine whether the mobile unit 200 has halted based on information acquired by the information acquirer 12 from the ECU or the like in the mobile unit 200. The monitoring support apparatus 10 may determine whether the mobile unit 200 has halted based on information acquired by the information acquirer 12 from various functional units or the like related to autonomous driving in the mobile unit 200.

If it is determined in step S11 that the mobile unit 200 has halted, the identifier 13 identifies a target that has brought the mobile unit 200 to a halt (step S12). In step S12, the identifier 13 may identify the target that has brought the mobile unit 200 to a halt based on an image acquired by the image acquirer 11. For example, the identifier 13 may identify the pedestrian P as the target that has brought the mobile unit 200 to a halt in a situation illustrated in FIG. 6A. If a functional unit related to the autonomous driving in the mobile unit 200 identifies a target that has brought the mobile unit 200 to a halt in step S12, the information acquirer 12 may acquire the result of such identification from the mobile unit 200. When the target that has brought the mobile unit 200 to a halt is identified in step S12, the monitoring support apparatus 10 may save the position of the target to the memory 15. The position of the target may be defined as the position at which the target that has brought the mobile unit 200 to a halt is present in the image acquired by the image acquirer 11.

Once the target is identified in step S12, the image generator 14 generates an image depicting an object indicating the position of the target that has brought the mobile unit 200 to a halt (step S13). The object indicating the position of the target that has brought the mobile unit 200 to a halt in step S13 may be any object depicted to alert the watcher WA that the target located at the position has brought the mobile unit 200 to a halt. In other words, looking at the object, the watcher WA is able to easily grasp that the target located at the position of the object has brought the mobile unit 200 to a halt. In an embodiment, when the identifier 13 has identified a target that has brought the mobile unit 200 to a halt, the image generator 14 may generate an image depicting an object indicating the position of the target in this way.

In response to the monitoring support apparatus 10 outputting the image depicting the object generated in step S13, the display 130 may present a screen such as the screen 130A illustrated in FIG. 6B. The screen 130A in FIG. 6B presents an object OB1 indicating the position of the target (pedestrian P) that has brought the mobile unit 200 to a halt. The object OBI may have any shape, any color, and any display mode. To alert the watcher WA to the cause of the halt of the mobile unit 200, the object OBI may be, for example, a red rectangular frame or the like enclosing the pedestrian P.

Following step S13, the monitoring support apparatus 10 determines whether the target that has brought the mobile unit 200 to a halt is still present in the image acquired by the image acquirer 11 (step S14). In step S14, for example, it may be determined whether the identifier 13 still keeps identifying in the image acquired by the image acquirer 11 the target that has brought the mobile unit 200 to a halt.

If the target is still present in step S14, the monitoring support apparatus 10 saves, for example, to the memory 15 the position of the target at predetermined intervals (step S15). The position of the target may be defined as the position at which the target that has brought the mobile unit 200 to a halt is present in the image acquired by the image acquirer 11. The predetermined interval may be set to any period, such as one second, in step S15. For example, the predetermined interval may be set so that movement (change in the position) of the target that has brought the mobile unit 200 to a halt is grasped. The predetermined interval may be set to a different value that depends on, for example, a type of the target and/or a moving speed of the target. For example, the predetermined interval may be set to a shorter time for a target moving faster than for a target moving slower. For example, the predetermined interval may be set to a shorter time when a target identified by the identifier is an object that moves faster (for example, a vehicle or a motorcycle) than when a target is an object that moves slower (pedestrian).

After the position of the target is saved in step S15, the monitoring support apparatus 10 may return to step S13 and repeat the operation. If the target that has brought the mobile unit 200 to a halt changes the position before the operation in step S13 is performed after step S15, the image generator 14 may generate an image depicting an object indicating the latest position at the time.

In this way, the loop from step S13 to step S15 enables the monitoring support apparatus 10 to output images illustrated in FIG. 6B to FIG. 6E using the screen 130A. As illustrated in FIG. 6B to FIG. 6E, the screen 130A presents the pedestrian P crossing the road on foot from right to left. The monitoring support apparatus 10 presents in the screen 130A the object OB1, which follows movement of the pedestrian P, to indicate the position of the pedestrian P (target that has brought the mobile unit 200 to a halt), who is moving. In this way, the image generator 14 may generate an image depicting the object OB1, which follows the change in the position of the target that has brought the mobile unit 200 to a halt.

Looking at the object OBI (and the image of the pedestrian P) in the screen 130A illustrated in FIG. 6B to FIG. 6E, the watcher WA is able to easily grasp that the target that has brought the mobile unit 200 to a halt is still present.

FIG. 6F illustrates a situation that occurs after the situations illustrated in FIG. 6B to FIG. 6E. FIG. 6F illustrates a situation in which the pedestrian P is not present any more in the image acquired by the image acquirer 11 because the pedestrian P has moved further after the movement of the pedestrian P illustrated in FIG. 6B to FIG. 6E.

As described above, for example, when the watcher WA looks at the screen 130A illustrated in FIG. 6F to try to resume monitoring the mobile unit 200 after responding to a mobile unit other than the mobile unit 200, the watcher WA is unable to easily grasp the target that has brought the mobile unit 200 to a halt. For example, when the watcher WA first looks at the screen 130A as illustrated in FIG. 6F to start monitoring the mobile unit 200, the watcher WA is unable to easily grasp the current status of the mobile unit 200. When the watcher WA is to remotely take over the control of the mobile unit 200, the watcher WA is unable to easily grasp by looking at the screen 130A illustrated in FIG. 6F whether the mobile unit 200 was going forward or turning to the right before the halt.

Thus, in an embodiment, the monitoring support apparatus 10 performs an operation in step S16 when it is determined in step S14 that the target is not present any more. In step S14, if the target that has brought the mobile unit 200 to a halt is not captured in the image acquired by the image acquirer 11, the monitoring support apparatus 10 may determine that the target is not present any more. In step S14, if the identifier 13 stops identifying the target that has brought the mobile unit 200 to a halt in the image acquired by the image acquirer 11, it may be determined that the target is not present any more.

In step S16, the image acquirer 11 may generate an image depicting, in the current image, an object indicating the position of the target at the time of the halt of the mobile unit 200, the target having caused the halt. The position of the target at the time of the halt of the mobile unit 200, the target having caused the halt, may be set to, for example, the position at which the target is recognized for the first time in step S13. In other words, the object indicating the position of the target in step S16 may be set to an object indicating the position at which the target that has brought the mobile unit 200 to a halt is identified for the first time.

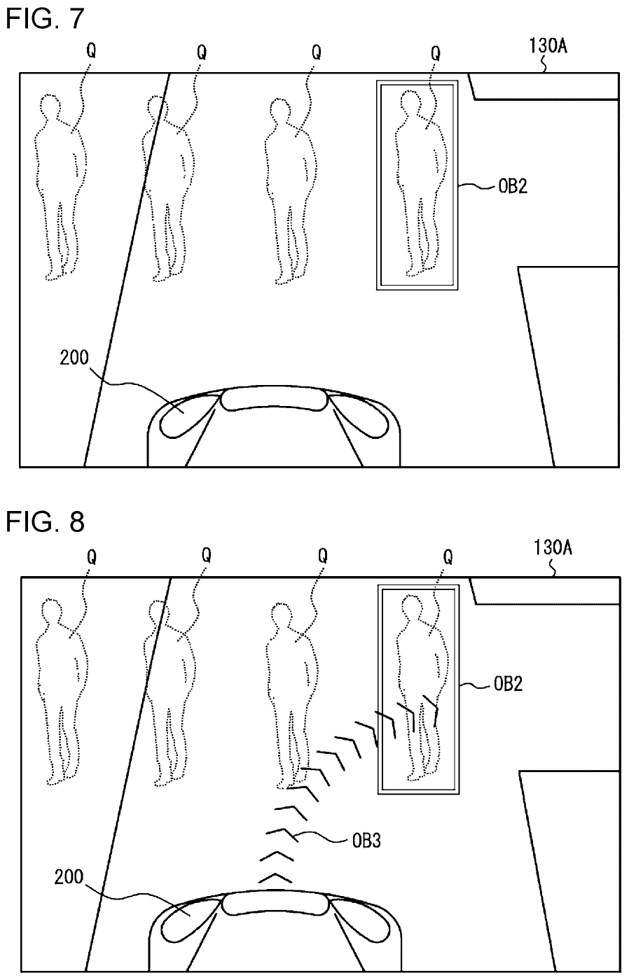

In response to a picture depicting the object generated in step S16 being output from the monitoring support apparatus 10, the display 130 may present, for example, an object OB2 depicted in the screen 130A in FIG. 7. The object OB2 may have any shape, any color, and any display mode. The object OB2 may be depicted differently from the object OB1 (FIG. 6B to FIG. 6E) referred to in step S13. While indicating the position at which the target that has brought the mobile unit 200 to a halt was originally present, the object OB2 may be an object indicating that the target has already disappeared from the screen. For example, the object OB2 may be a blue or green rectangular frame or the like enclosing the pedestrian P to alert the watcher WA that the cause of the halt of the mobile unit 200 has already disappeared.

In this way, the image generator 14 may generate an image depicting the object OB2 in the current image, the object OB2 indicating the position of the target at which the identifier 13 has identified the target that has brought the mobile unit 200 to a halt. The image generator 14 may perform the above operation when the identifier 13, which keeps identifying the target that has brought the mobile unit 200 to a halt, stops identifying the target based on the image acquired by the image acquirer 11.

In response to the image depicting the object OB2 being generated in step S16, the image generator 14 performs an operation in step S17. In step S17, the image generator 14 changes a display mode of the target and generates images indicating the position of the target at predetermined intervals during a period from a time that the identifier 13 identifies the target that has brought the mobile unit 200 to a halt to the present (step S17). The image generator 14 may generate images indicating the position of the target at the predetermined intervals during a predetermined period after the identifier 13 identifies the target that has brought the mobile unit 200 to a halt. The image generator 14 may generate images indicating the position of the target at the predetermined intervals after the identifier 13 identifies the target that has brought the mobile unit 200 to a halt until the target disappears from the screen. The image generator 14 may generate images indicating the position of the target at the predetermined intervals for a predetermined period that ends at a time of disappearance from the screen of the target identified by the identifier 13 as the cause of the halt of the mobile unit 200. The image generator 14 may generate images indicating the position of the target at the predetermined intervals for a predetermined period during which the target identified by the identifier 13 as the cause of the halt of the mobile unit 200 is present in the screen. The position of the target at the predetermined intervals may be set to, for example, the position of the target saved to the memory 15 in step S15. In short, in step S17, the image generator 14 generates images indicating the position of the target at the predetermined intervals as illustrated, for example, in FIG. 6B to FIG. 6E. If an image of the target that has brought the mobile unit 200 to a halt is superposed onto an image from which the target has already disappeared, the watcher WA may have difficulty in determining whether the image of the target represents the presence of the target or a virtual image. Thus, in step S17, the image generator 14 may generate images indicating the position of the target at the predetermined intervals after performing appropriate image processing such as rendering the target semi-transparent. For example, the image generator 14 may superpose, at the positions of the target as illustrated in FIG. 6B to FIG. 6E, an image having a display mode differing from the display mode of the image of the target (pedestrian P) as illustrated in FIG. 6B to FIG. 6E.

For example, the image generator 14 may render the image of the pedestrian P semi-transparent and present the image like an image Q of the pedestrian illustrated in FIG. 7. The image generator 14 may present the image of the pedestrian P in a display mode differing from the display mode of the image Q of the pedestrian illustrated in FIG. 7, for example, presenting only the outline of the image of the pedestrian P or presenting the image of the pedestrian P in a grayed-out state.

In this way, the image generator 14 may generate a superposed image depicting at the predetermined intervals in the image acquired by the image acquirer 11 a picture obtained by changing the display mode of the target that has brought the mobile unit 200 to a halt. The image generator 14 may generate as the superposed image described above an image depicting in the current image acquired by the image acquirer 11 a picture, for example, rendered semi-transparent of the image of the target that has brought the mobile unit 200 to a halt. The image generator 14 may generate the superposed image described above when the identifier 13, which keeps identifying the target that has brought the mobile unit 200 to a halt, stops identifying the target based on the image acquired by the image acquirer 11.

Looking at the screen 130A illustrated in FIG. 7, the watcher WA is able to easily grasp that the target that has brought the mobile unit 200 to a halt was originally located at the position of the object OB2. Looking at the object OBI as illustrated in FIG. 6B to FIG. 6E, the watcher WA is able to easily grasp that the target that has brought the mobile unit 200 to a halt is still in the screen 130A. In summary, looking at the object OBI as illustrated in FIG. 6B to FIG. 6E, the watcher WA is able to easily grasp that the current situation does not allow the mobile unit 200 to safely resume moving.

In contrast, looking at the object OB2 illustrated in FIG. 7 instead of the object OB1 as illustrated in FIG. 6B to FIG. 6E, the watcher WA is able to easily grasp that the target that has brought the mobile unit 200 to a halt is not present in the screen 130A any more. Looking at the image Q of the pedestrian illustrated in FIG. 7, the watcher WA is able to easily grasp how the target that is already absent from the screen 130A has disappeared from the screen 130A. In this way, looking at the screen 130A illustrated in FIG. 7, the watcher WA is able to easily grasp that the mobile unit 200 is allowed to safely resume moving.

In an embodiment, the image generator 14 may further perform an operation in step S18 after the operation in step 17. Namely, in step S18, the image generator 14 may generate an image depicting an object indicating an originally planned path.

For example, when the mobile unit 200 is autonomously driven, the information acquirer 12 is able to acquire information regarding a planned path before the mobile unit 200 is brought to a halt in step S11. When the mobile unit 200 runs under the control of a car navigation system, the information acquirer 12 is also able to acquire information regarding a planned path before the mobile unit 200 is brought to a halt in step S11.

Thus, if it is determined in step S14 that the target is not present any more, the image generator 14 may present an object indicating a planned path to be taken by the mobile unit 200 after the halt (step S18).

FIG. 8 illustrates an object OB3 added to the screen 130A illustrated in FIG. 7, the object OB3 indicating a planned path to be taken by the mobile unit 200 after the halt. As illustrated in FIG. 8, the object OB3 may present a road to be taken by the mobile unit 200 in an easily understandable way. The object OB3 may have any size, any shape, any color, and any display mode as an object indicating a planned path. Looking at the object OB3 in the screen 130A illustrated in FIG. 7, the watcher WA is able to easily grasp the path to be taken when the mobile unit 200 resumes running after the halt.

In this way, the image generator 14 may generate an image depicting the object OB3 indicating the planned path for the mobile unit 200. The image generator 14 may perform the above operation when the identifier 13, which keeps identifying the target that has brought the mobile unit 200 to a halt, stops identifying the target based on the image acquired by the image acquirer 11.

As described above, in an embodiment, when a mobile unit is brought to a halt, the monitoring support apparatus 10 is able to allow the watcher to easily grasp the situation that has caused the halt. In an embodiment, when a mobile unit is brought to a halt, the monitoring support apparatus 10 is able to allow the watcher to easily grasp a planned path to be taken by the mobile unit after the halt. Thus, in an embodiment, the monitoring support apparatus 10 enables a reduction in a load on a person who monitors a traffic condition for a mobile unit.

An embodiment according to the present disclosure has been described based on the drawings and the example. Note that those skilled in the art easily perform various variations or corrections based on the present disclosure. Accordingly, note that those variations or corrections are within the scope of the present disclosure. For example, each constituent or a function included in each step or the like may be rearranged in a logically compatible manner, and combining multiple constituents or steps or the like into one or dividing a constituent or a step or the like is possible. Although the description has been given mainly with regard to the apparatus according to an embodiment of the present disclosure, an embodiment of the present disclosure may be practiced as a method including a step performed by each constituent in the apparatus. An embodiment of the present disclosure may also be practiced as a method to be performed by a processor included in an apparatus, a program, or a recording medium storing such a program. It should be appreciated that such a method, such a program, and such a recording medium are also within the scope of the present disclosure.

The embodiment described above may be practiced, for example, as a method for controlling an electronic apparatus such as the monitoring support apparatus described above. The embodiment described above may be practiced, for example, as a system including the monitoring support apparatus described above. For example, the embodiment described above may be practiced as a monitoring support system including the monitoring support apparatus 10, the communicator 120, and the display 130. In such a case, the display 130 may present an image generated by the image generator 14 in the monitoring support apparatus 10. The monitoring support system may further include, instead of or together with the communicator 120, the imager 210 configured to capture an image. The embodiment described above may be practiced, for example, as a program to be performed by the monitoring support apparatus or the monitoring support system described above. The embodiment described above may be practiced, for example, as a recording medium, that is, a computer-readable recording medium storing a program to be performed by the monitoring support apparatus or the monitoring support system described above.

When the embodiment described above is practiced as a program, the program may include instructions causing a computer to execute
acquiring an image observed from a mobile unit and captured;
obtaining information regarding a target that has brought the mobile unit to a halt; and
generating a superposed image by displaying, in the image acquired by the acquiring, a picture indicating a position of the target during a predetermined period.

### REFERENCE SIGNS

1 monitoring support system
10 monitoring support apparatus
11 image acquirer
12 information acquirer
13 identifier
14 image generator
15 memory
120 communicator
130 display
200 mobile unit
210 imager
220 communicator
300 remote controller

1. A monitoring support apparatus comprising:
an image acquirer configured to acquire an image observed from a mobile unit and captured;
an image generator configured to generate a superposed image by displaying in the image acquired by the image acquirer a picture indicating a position of a target that has brought the unit to a halt during a predetermined period.

2. The monitoring support apparatus according to claim 1,
comprising an identifier configured to identify the target included in the image acquired by the image acquirer,
wherein the superposed image depicts in the image acquired by the image acquirer a picture indicating the position of the target during the predetermined period after the identifier identifies the target that has brought the mobile unit to a halt.

3. The monitoring support apparatus according to claim 1,
wherein the superposed image depicts in the image acquired by the image acquirer a picture indicating the position of the target until the target disappears from the image acquired by the image acquirer.

4. The monitoring support apparatus according to claim 1,
wherein the superposed image depicts in the image acquired by the image acquirer pictures indicating the position of the target at predetermined intervals.

5. The monitoring support apparatus according to claim 4,
wherein the predetermined intervals are determined depending on a type of the target or a moving speed of the target.

6. (canceled)

7. The monitoring support apparatus according to claim 2,
wherein the identifier is configured to identify the target by the target being specified in the image acquired by the image acquirer.

8. The monitoring support apparatus according to claim 1,
wherein the image generator is configured to generate an image as the superposed image by overlaying a picture of the target rendered semi-transparent onto the image acquired by the image acquirer, the picture being generated from an image of the target acquired by the image acquirer.

9. The monitoring support apparatus according to claim 2,
wherein the image generator is configured to
at a time that the identifier that keeps identifying the target stops identifying the target based on the image acquired by the image acquirer,
generate an image depicting an object indicating a planned path of the mobile unit.

10. A monitoring support system comprising:
a communicator configured to receive an image observed from a mobile unit and captured;
an image acquirer configured to acquire the image received by the communicator;
an image generator configured to generate a superposed image by displaying in the image acquired by the image acquirer a picture indicating a position of a target that bas brought the mobile unit to a halt during a predetermined period; and
a display configured to present the image generated by the image generator.

11. A program comprising instructions causing a computer to execute
acquiring an image observed from a mobile unit and captured;
generating a superposed image by displaying, in the image acquired by the acquiring, a picture indicating a position of a target that has brought the mobile unit to a halt during a predetermined period.

12. The monitoring support apparatus according to claim 1,
wherein the image generator is configured to display in the image acquired by the image acquirer a picture indicating at least one past position of the target.
